(19) United States
(12) Patent Application Publication
(10) Pub. No.: US 2009/0092369 A1
(43) Pub. Date: Apr. 9, 2009

(54) Video controller and method for processing video signal

(75) Inventors: Rei-Hong Chang, Hsinchu City (TW); Wei-Chen Su, Tainan County (TW)

Correspondence Address: RABIN & Berdo, PC, 1101 14TH STREET, NW, SUITE 500, WASHINGTON, DC, 20005, US

(73) Assignee: NOVATEK MICROELECTRONICS CORP., Hsinchu (TW)

(21) Appl. No.: 12/003,419

(22) Filed: Dec. 26, 2007

(30) Foreign Application Priority Data
Oct. 5, 2007 (TW) 96137574

(51) Int. Cl. H04N 9/79

(52) U.S. Cl. 386/34

(57) ABSTRACT

A video controller including a switching device, an analog-to-digital converter and a digital video processor is provided. The switching device is for receiving an analog video sync signal and a first analog video signal, and combining the analog video sync signal with the first analog video signal to form a mixing signal according to a switching control signal. The analog video sync signal includes a specific video signal and a sync signal. A frequency of the switching control signal relates to a frequency of the sync signal. The analog-to-digital converter converts the mixing signal into a digital signal according to a sampling control signal. The digital video processor receives the digital signal and decodes the digital signal to generate a digital video sync signal and a first digital video signal.

This application claims the benefit of Taiwan application Serial No. 96137574, filed Oct. 5, 2007, the subject matter of which is incorporated herein by reference.

### BACKGROUND OF THE INVENTION

1. Field of the Invention

The invention relates in general to a video controller and a method for processing video signals, and more particularly to a video controller capable of reducing cost and a method for processing video signals.

2. Description of the Related Art

In a conventional display device or image processing device, normally an analog composite video signal or an analog component video signal is received and converted into a corresponding digital signal by a analog-to-digital converter for subsequent devices to perform digital image processing.

However, the analog component video signal is a multi-channel analog signal constituted by multiple analog signals, hence requiring multiple analog-to-digital converters to convert the analog signals into corresponding digital signals. Normally, an analog component video signal includes two analog signals namely a luminance signal (Y) and a chrominance signal (C) or includes three analog signals namely a luminance signal (Y) and two color-difference signals (Cb and Cr). In the following disclosure, for simply illustrate the present invention, we assume that the analog component video signal include a luminance signal (Y) and a chrominance signal (C).

Referring to FIG. 1, a block diagram of a conventional video controller is shown. The video controller 100 includes a first analog-to-digital converter 110, a second analog-to-digital converter 120 and a digital video processor 130. In the video controller 100, the first analog-to-digital converter 110 receives an analog luminance signal Y, and converts the analog luminance signal Y according to a clock signal CLK, and then outputs to the digital video processor 130 to obtain a digital luminance signal DY. The second analog-to-digital converter 120 receives an analog chrominance signal C and converts the analog chrominance signal C according to a clock signal CLK, and then outputs to the digital video processor 130 to obtain a digital chrominance signal DC.

In correspondence to the multi-channel analog component video signal, the conventional video controller 100 requires an equivalent number of analog-to-digital converters for converting the analog signal of respective channels, hence increasing the cost and power consumption. Therefore, how to develop a video controller with low cost and consuming low power has become an important issue to be resolved.

### SUMMARY OF THE INVENTION

The invention is directed to a video controller and a method for processing video signals. By means of a switching device, a multi-channel analog signal is converted into multiple corresponding digital signals by a single analog-to-digital converter, not only reducing the number of analog-to-digital converters but also reducing power consumption and cost.

According to a first aspect of the present invention, a video controller including a switching device, an analog-to-digital converter and a digital video processor is provided. The switching device is for receiving an analog video sync signal and a first analog video signal, and combining the analog video sync signal with the first analog video signal to form a mixing signal according to a switching control signal. The mixing signal, during multiple first periods, corresponds to the analog video sync signal; the mixing signal, during multiple second periods, corresponds to the first analog video signal. At least one second period is positioned between two successive first periods. The analog video sync signal includes a specific video signal and a sync signal. A frequency of the switching control signal relates to a frequency of the sync signal. The analog-to-digital converter converts the mixing signal into a digital signal according to a sampling control signal, and a frequency of the sampling control signal relates to the frequency of the switching control signal. The digital video processor receives the digital signal, and decodes the digital signal to generate a digital video sync signal and a first digital video signal. The digital video sync signal corresponds to the analog video sync signal, and the first digital video signal corresponds to the first analog video signal.

According to a second aspect of the present invention, a method for processing video signals is provided. The method includes the following steps. Firstly, an analog video sync signal and a first analog video signal are received, wherein the analog video sync signal includes a specific video signal and a sync signal. Next, the analog video sync signal and the first analog video signal are combined to form a mixing signal according to a switching control signal. The mixing signal, during multiple first periods, corresponds to the analog video sync signal; the mixing signal, during multiple second periods, corresponds to the first analog video signal. At least one second period is positioned between two successive first periods. A frequency of the switching control signal relates to a frequency of the sync signal. Then, a digital-to-analog conversion is performed on the mixing signal according to a sampling control signal to generate a digital signal, wherein a frequency of the sampling control signal relates to the frequency of the switching control signal. Afterwards, the digital signal is received and the digital signal is decoded to generate a digital video sync signal and a first digital video signal, wherein the digital video sync signal corresponds to the analog video sync signal, and the first digital video signal corresponds to the first analog video signal.

The invention will become apparent from the following detailed description of the preferred but non-limiting embodiments. The following description is made with reference to the accompanying drawings.

### BRIEF DESCRIPTION OF THE DRAWINGS

FIG. 1 is a block diagram of a conventional video controller;

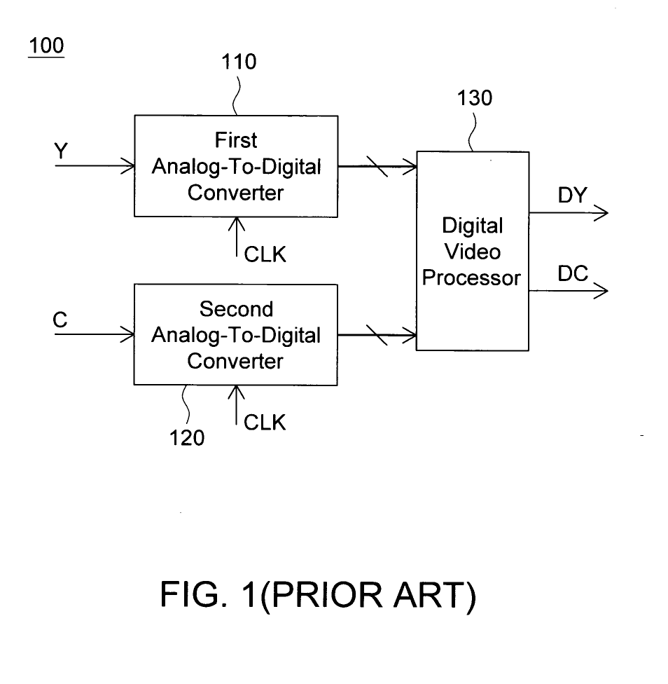

FIG. 2 is a block diagram of a video controller according to a first embodiment of the invention;

FIG. 3 is a wave-pattern of the signals of the video controller 200 according to the first embodiment of the invention;

FIG. 4A is a perspective of the video controller 300 according to a second embodiment of the invention;

FIG. 4B is a wave-pattern of the signals of the video controller 300 according to the second embodiment of the invention; and

FIG. 5 is a flowchart of processing video signals according to a preferred embodiment of the invention.

### DETAILED DESCRIPTION OF THE INVENTION

The invention provides a video controller and a method for processing video signals. By means of a switching device, a multi-channel analog signal is converted into many corresponding digital signals by a single analog-to-digital converter alone without using many analog-to-digital converters, such that power consumption and cost can be reduced.

### First Embodiment

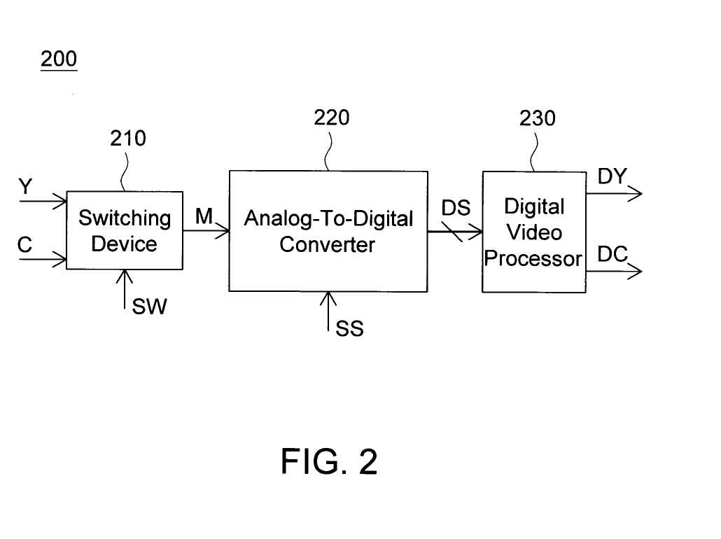

Referring to FIG. 2, a block diagram of a video controller according to a first embodiment of the invention is shown. The video controller 200 can be disposed in a display device or an image processing device. The video controller 200 includes a switching device 210, an analog-to-digital converter 220 and a digital video processor 230. When the video controller 200 receives a single-channel analog signal such as an analog composite video signal, the switching device 210 directly transmits the single-channel analog signal to the analog-to-digital converter 220. Then, the analog-to-digital converter 220 converts the single-channel analog signal into a single-channel digital signal, and then outputs the single-channel digital signal to the digital video processor 230 for subsequent image processing.

Furthermore, in this embodiment, when the video controller 200 receives a multi-channel analog signal, only one analog-to-digital converter is utilized to convert the multi-channel analog signal into multiple corresponding digital signals. The above mechanism will be illustrated in the following disclosure.

The above-mentioned multi-channel analog signal is exemplified by an analog component video signal and at least includes an analog video sync signal and an analog video signal. In the present embodiment of the invention, the analog component video signal is an S-video image signal but is not limited thereto. The S-video image signal is constituted by two analog signals, namely, a luminance signal (Y) and a chrominance signal (C). The abovementioned analog video sync signal is exemplified by an analog luminance signal Y, and the abovementioned analog video signal is exemplified by an analog chrominance signal C. The analog luminance signal Y includes a specific video signal and a sync signal. The sync signal of the analog luminance signal Y can be obtained by means of a phase locked loop (PLL), and the frequency of the sync signal is 27 MHz for example.

The switching device 210 is exemplified by a multiplexer and is for receiving the analog luminance signal Y and the analog chrominance signal C. The switching device 210 combines the analog luminance signal Y with the analog chrominance signal C according to a switching control signal SW to form a mixing signal. The mixing signal corresponds to the analog luminance signal Y during multiple first periods, the mixing signal corresponds to the analog chrominance signal C during multiple second periods, and at least one second period is positioned between two successive first periods. The frequency of the switching control signal SW relates to the frequency of the sync signal. For example, the frequency of the switching control signal SW is also 27 MHz.

Preferably, the frequency of the switching control signal SW relates to the frequency of the analog luminance signal Y and the analog chrominance signal C.

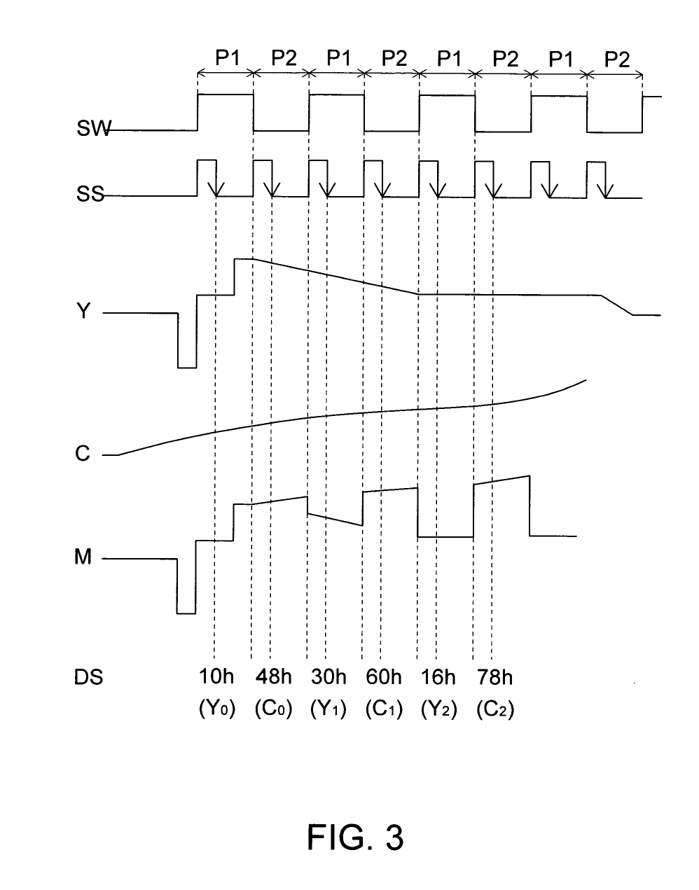

Referring to FIG. 3, a wave-pattern of the signals of the video controller 200 according to the first embodiment of the invention is shown. During the first periods P1 (for example, when the switching control signal SW is at a high voltage level), the switching device 210 selects and outputs the analog luminance signal Y as a mixing signal M. During the second periods P2 (for example, the switching control signal SW is at a low voltage level), the switching device 210 selects and outputs the analog chrominance signal C as the mixing signal M. Preferably, each second period P2 is positioned between two successive first periods P1. Thus, the switching device 210 combines the analog luminance signal Y with the analog chrominance signal C, and alternately outputs the analog luminance signal Y and the analog chrominance signal C to obtain the mixing signal M.

The analog-to-digital converter 220 converts the mixing signal M into a digital signal DS according to a sampling control signal SS, wherein the frequency of the sampling control signal SS relates to the frequency of the switching control signal SW. For example, the frequency of the sampling control signal SS is an integer multiple of the frequency of the switching control signal SW. If the frequency of the switching control signal SW is 27 MHz, then the frequency of the sampling control signal SS is approximately 54 MHz. Referring to FIG. 3, the analog-to-digital converter 220 samples the mixing signal M at the falling edges of the sampling control signal SS to obtain the digital signal DS, but is not limited thereto. The digital signal DS can be an 8-bit signal or a 10-bit signal. In the present embodiment of the invention, the digital signal DS is substantially formed by alternate digital values of the sampled and converted analog luminance signal Y and analog chrominance signal C. For example, the digital signal DS is Y₀, C₀, Y₁, C₁, Y₂, C₂ and so on.

The digital video processor 230 is used for receiving the digital signal DS, and decoding the digital signal DS to derive a digital luminance signal DY and a digital color chrominance signal DC, wherein the digital luminance signal DY is the digital video signal (such as Y₀, Y₁, Y₂ and so on) corresponding to the analog luminance signal Y and the digital color chrominance signal DC is the digital video signal (such as C₀, C₁, C₂ and so on) corresponding to the analog chrominance signal C. Thus, the present embodiment of the invention can perform the analog-to-digital conversion on the analog luminance signal Y and the analog chrominance signal C by using only one single analog-to-digital converter 220, hence reducing cost and saving energy.

### Second Embodiment

The present embodiment of the invention differs with the first embodiment in that the number of channels of the multi-channel analog signal received by the video controller is greater than 2. For example, if the analog component video signal is constituted by three analog signals, namely, an analog luminance signal (Y) and two analog color-difference signals (Cb and Cr), the switching device combines the analog luminance signal Y with the analog color-difference signals Cb and Cr according to the switching control signal SW′ to form a mixing signal M′. The mixing signal M′ corresponds to the analog luminance signal Y during the first periods, the mixing signal M′ corresponds to the analog color-difference signal Cb during the second periods, and the mixing signal M′ corresponds to the analog color-difference signal Cr during the third periods.

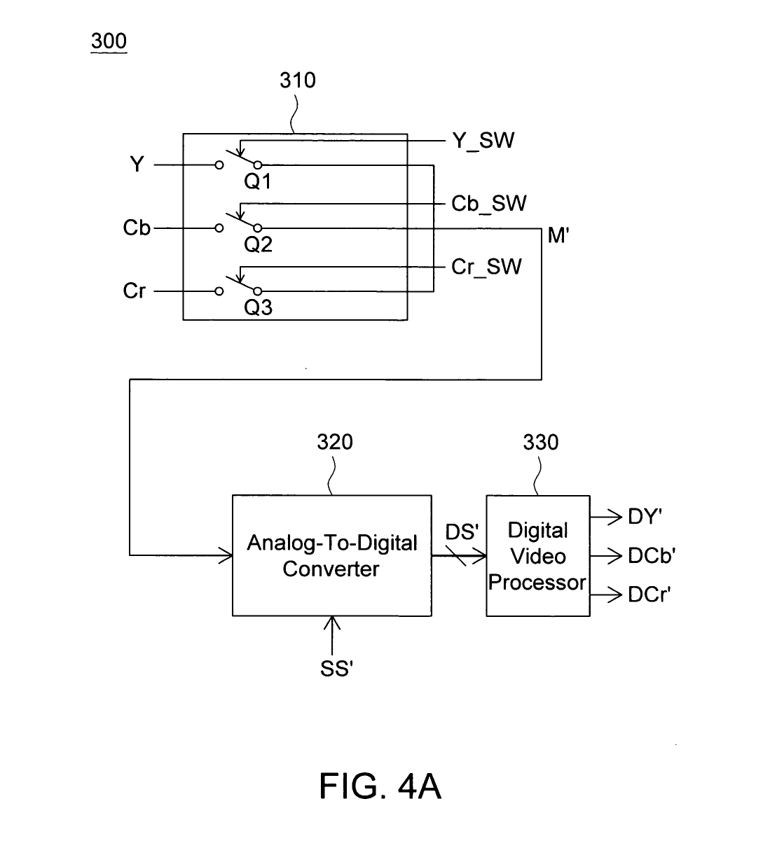

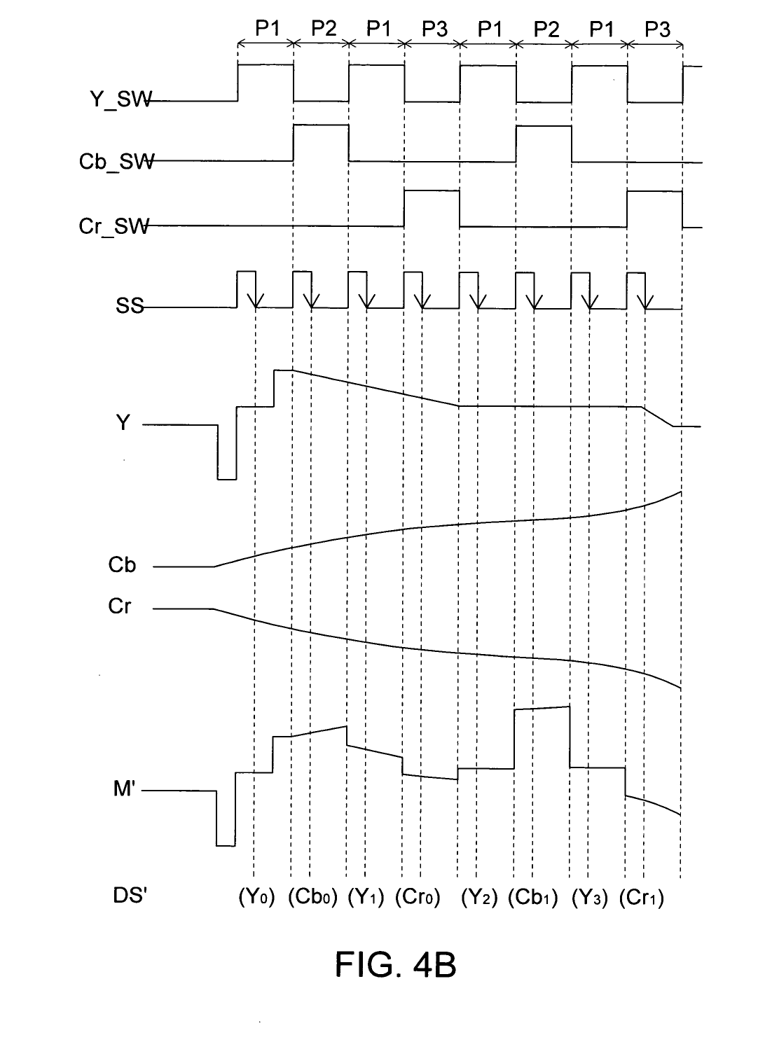

Referring to FIG. 4A, a perspective of the video controller 300 according to a second embodiment of the invention is shown. In the video controller 300, the switching device 310 is, for example, controlled by the switching control signal SW′. The switching control signal SW′ includes a first switching control signal Y_SW, a second switching control signal Cb_SW and a third switching control signal Cr_SW, wherein the frequency of the first switching control signal Y_SW is 27 MHz and the second and the third switching control signals Cb_SW and Cr_SW are both 13.5 MHz.

The switching device 310 includes three switches Q1˜Q3, wherein the switch Q1 is controlled by the first switching control signal Y_SW, the switch Q2 is controlled by the second switching control signal Cb_SW, and the switch Q3 is controlled by the third switching control signal Cr_SW. The switches Q1˜Q3 are respectively controlled by corresponding switching control signal and combine the analog luminance signal Y and the analog color-difference signals Cb and Cr to form the mixing signal M′.

Referring to FIG. 4B, a wave-pattern of the signals of the video controller 300 according to the second embodiment of the invention is shown. During the first periods P1, the switching device 210 selects and outputs the analog luminance signal Y. During the second periods P2, the switching device 210 selects and outputs the analog color-difference signal Cb, wherein the second period P2 is positioned between two successive first periods P1. During the third periods P3, the switching device 210 selects and outputs the analog color-difference signal Cr, wherein the third period P3 is positioned between two neighboring first periods P1. As shown in FIG. 4B, preferably, the second period P2 and the third period P3 alternatively appear between two successive first periods P1. During the first period P1, the first switching control signal Y_SW is enabled, and the voltage thereof is at a high voltage level; the second switching control signal Cb_SW and the third switching control signal Cr_SW are disabled, and the voltage level thereof is at a low voltage level. During the second period P2, the voltage levels of the first switching control signal Y_SW and the third switching control signal Cr_SW are disabled, the voltage level of the second switching control signal Cb_SW is enabled. During the third period P3, the first switching control signal Y_SW and the second switching control signal Cb_SW are disabled, and the voltage level of third switching control signal Cr_SW is enabled. Thus, the switching device 210 can combine the analog luminance signal Y with analog color-difference signal Cb and Cr to form the mixing signal M′.

Next, the analog-to-digital converter 320 converts the mixing signal M′ into a digital signal DS′ according to the sampling control signal SS′, and then outputs the digital signal DS′ to the digital video processor 330 for decoding multiple digital video signals corresponding to the analog luminance signal Y and the analog color-difference signals Cb and Cr. The frequency of the sampling control signal SS′ is exemplified by (27+13.5×2)=54 MHz.

Referring to FIG. 4B, the analog-to-digital converter 220 samples at the falling edges of the sampling control signal SS′ to obtain the digital signal DS′. In the present embodiment of the invention, the digital signal DS′ is substantially formed by alternate digital signals corresponding to the analog luminance signal Y and the analog color-difference signals Cb and Cr. For example, the digital signal DS′ is Y₀, Cb₀, Y₁, Cr₀, Y₂, Cb₁, Y₃, Cr₁ and so on. Afterwards, the digital video processor 330 decodes the digital signal DS′ to derive the digital luminance signal DY′ and the digital color-difference signals DCb′ [symbol] DCr′. The digital luminance signal DY′ corresponds to analog luminance signal Y, and the digital color-difference signals DCb′ and DCr′ respectively correspond to the analog color-difference signals Cb and Cr.

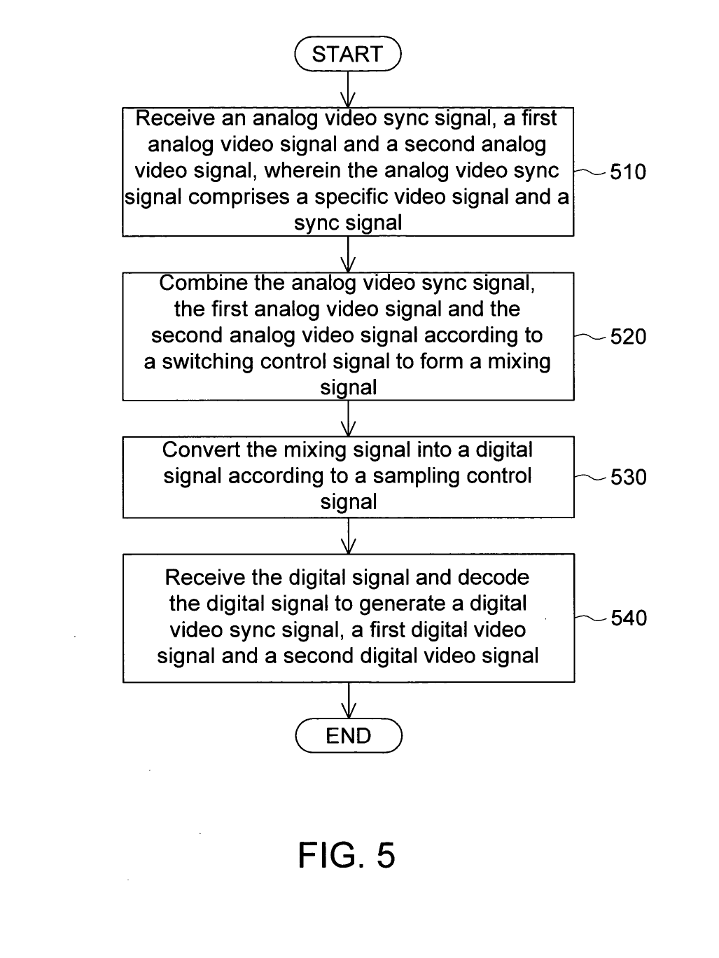

The invention further provides a method for processing video signals. Referring to FIG. 5, a flowchart of processing video signals according to a preferred embodiment of the invention. Firstly, the method begins at step 510, an analog video sync signal, a first analog video signal and a second analog video signal are received, wherein the analog video sync signal includes a specific video signal and a sync signal. Next, the method proceeds to step 520, the analog video sync signal, the first analog video signal and the second analog video signal are combined according to a switching control signal to form a mixing signal, wherein the mixing signal corresponds to the analog video sync signal during the first periods, the mixing signal corresponds to the first analog video signal during the second periods, and the mixing signal corresponds to the second analog video signal during the third periods. The second period is positioned between two successive first periods, and the third period is positioned between two successive first periods. The frequency of the switching control signal relates to the frequency of the sync signal.

Then, the method proceeds to step 530, the mixing signal is converted into a digital signal according to a sampling control signal, wherein the frequency of the sampling control signal relates to the frequency of the switching control signal. Afterwards, the method proceeds to step 540, the digital signal is received, and the digital signal is decoded to derive a digital video sync signal, a first digital video signal and a second digital video signal, wherein, the digital video sync signal corresponds to the analog video sync signal, the first digital video signal corresponds to the first analog video signal, and the second digital video signal corresponds to the second analog video signal.

In the above-mentioned method for processing video signals, the analog video sync signal, the first analog video signal and the second analog video signal are component video signals. For example, the analog video sync signal is an analog luminance signal (Y), the first analog video signal and the second analog video signal respectively are the analog color-difference signal (Cb) and the analog color-difference signal (Cr).

According to the video controller and the method for processing video signals disclosed in the above embodiment of the invention, by means of a switching device, a multi-channel analog signal is converted to many corresponding digital signals by using one single analog-to-digital converter and the digital video sync signal and digital video signal are split by the digital video processor, not only effectively reducing the required number of analog-to-digital converters, but also reducing power consumption and cost.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A video controller, comprising:
a switching device for receiving an analog video sync signal and a first analog video signal and combining the analog video sync signal with the first analog video signal according to a switching control signal to form a mixing signal, wherein the mixing signal corresponds to the analog video sync signal during a plurality of first periods, the mixing signal corresponds to the first analog video signal during a plurality of second periods, at least one second period is positioned between two successive first periods, the analog video sync signal comprises a specific video signal and a sync signal, and a frequency of the switching control signal relates to a frequency of the sync signal;
an analog-to-digital converter for converting the mixing signal into a digital signal according to a sampling control signal, wherein a frequency of the sampling control signal relates to the frequency of the switching control signal; and
a digital video processor for receiving the digital signal and decoding the digital signal to generate a digital video sync signal and a first digital video, wherein the digital video sync signal corresponds to the analog video sync signal, and the first digital video signal corresponds to the first analog video signal.

2. The video controller according to claim 1, wherein the frequency of the sampling control signal is an integer multiple of the frequency of the switching control signal.

3. The video controller according to claim 1, wherein the switching device is a multiplexer controlled by the switching control signal for combining the analog video sync signal with the first analog video signal to form the mixing signal.

4. The video controller according to claim 1, wherein the analog video sync signal and the first analog video signal are component video signals.

5. The video controller according to claim 4, wherein the analog video sync signal is an analog luminance signal (Y), and the first analog video signal is an analog chrominance signal (C).

6. The video controller according to claim 1, wherein the switching device further receives a second analog video signal and further combines the analog video sync signal, the first analog video signal and the second analog video signal according to the switching control signal to form the mixing signal, the mixing signal corresponds to the second analog video signal during a plurality of third periods, and at least one third period is positioned between two successive first periods.

7. The video controller according to claim 6, wherein the digital video processor decodes the digital signal to generate the digital video sync signal, the first digital video signal and a second digital video signal, the digital video sync signal corresponds to the analog video sync signal, the first digital video signal corresponds to the first analog video signal, and the second digital video signal corresponds to the second analog video signal.

8. The video controller according to claim 6, wherein the analog video sync signal, the first analog video signal and the second analog video signal are component video signals.

9. The video controller according to claim 8, wherein the analog video sync signal is an analog luminance signal (Y), the first analog video signal and the second analog video signal are respectively an analog color-difference signal (Cb) and an analog color-difference signal (Cr).

10. A method for processing video signals, the method comprising:
receiving an analog video sync signal and a first analog video signal, wherein the analog video sync signal comprises a specific video signal and a sync signal;
combining the analog video sync signal with the first analog video signal according to a switching control signal to form a mixing signal, wherein the mixing signal corresponds to the analog video sync signal during a plurality of first periods, the mixing signal corresponds to the first analog video signal during a plurality of second periods, at least one second period is positioned between two successive first periods, and a frequency of the switching control signal relates to a frequency of the sync signal;
performing an analog-to-digital conversion on the mixing signal according to a sampling control signal to form a digital signal, wherein a frequency of the sampling control signal relates to the frequency of the switching control signal; and
receiving the digital signal and decoding the digital signal to generate a digital video sync signal and a first digital video signal, wherein the digital video sync signal corresponds to the analog video sync signal, and the first digital video signal corresponds to the first analog video signal.

11. The method for processing video signals according to claim 10, wherein the frequency of the sampling control signal is an integer multiple of the frequency of the switching control signal.

12. The method for processing video signals according to claim 10, wherein the analog video sync signal and the first analog video signal are component video signals.

13. The method for processing video signals according to claim 12, wherein the analog video sync signal is an analog luminance signal (Y), and the first analog video signal is an analog chrominance signal (C).

14. The method for processing video signals according to claim 10, further comprising:
receiving a second analog video signal; and
combining the analog video sync signal, the first analog video signal and the second analog video signal according to the switching control signal to from the mixing signal, the mixing signal corresponds to the second analog video signal during a plurality of third periods, and at least one third period is positioned between two successive first periods.

15. The method for processing video signals according to claim 14, further comprising:
decoding the digital signal to generate the digital video sync signal, the first digital video signal and a second digital video signal, wherein the digital video sync signal corresponds to the analog video sync signal, the first digital video signal corresponds to the first analog video signal, and the second digital video signal corresponds to the second analog video signal.

16. The method for processing video signals according to claim 15, wherein the analog video sync signal, the first analog video signal and the second analog video signal are component video signals.

17. The method for processing video signals according to claim 16, wherein the analog video sync signal is an analog luminance signal (Y), and the first analog video signal and the second analog video signal are respectively an analog color-difference signal (Cb) and an analog color-difference signal (Cr).
